(19) United States
(12) Patent Application Publication
(10) Pub. No.: US 2014/0201833 A1
(43) Pub. Date: Jul. 17, 2014

(54) ELECTRONIC DEVICE AND METHOD FOR FAST ACTIVATING APPLICATION AFTER UNLOCKING

(71) Applicants: HON HAI PRECISION INDUSTRY CO., LTD., New Taipei (TW); Fu Tai Hua Industry (Shenzhen) Co., Ltd., Shenzhen (CN)

(72) Inventor: XIAO-RONG WANG, Shenzhen (CN)

(73) Assignees: HON HAI PRECISION INDUSTRY CO., LTD., New Taipei (TW); Fu Tai Hua Industry (Shenzhen) Co., Ltd., Shenzhen (CN)

(21) Appl. No.: 14/106,984

(22) Filed: Dec. 16, 2013

(30) Foreign Application Priority Data
Jan. 14, 2013 (CN) 2013100123435

(51) Int. Cl. G06F 21/36; G06F 3/0488

(52) U.S. Cl. CPC G06F 21/36; G06F 3/0488
USPC 726/19

(57) ABSTRACT

A method for fast activating applications of an electronic device having a touch screen displays a predetermined unlocking interface on the touch screen when the electronic device wakes from an idle state. The predetermined unlocking interface includes a plurality of pattern drawing regions. Each pattern drawing region corresponds to a predetermined application of the electronic device. When a pattern drawn by the user within any of the pattern drawing regions is the same as a preset unlocking pattern, the electronic device is unlocked. Then, an application of the electronic device corresponding to one of the pattern drawing regions in which the pattern is drawn is activated.

### BACKGROUND

1. Technical Field

Embodiments of the present disclosure relate to unlocking of electronic devices, and particularly, to a method for fast activating applications of an electronic device after the electronic device has been unlocked.

2. Description of Related Art

Many electronic devices, such as smart phones and tablet computers, have unlocking functions to avoid unintended operations. Various kind of unlocking methods applied in the electronic devices include unlocking by gestures, passwords, and patterns. When a user wants to open a commonly used application in the electronic device, the user must first unlock the electronic device before the user can operate an icon to activate the application, which is inconvenient and time consuming. Therefore, there is room for improvement in the art.

### BRIEF DESCRIPTION OF THE DRAWINGS

FIG. 1 is a schematic block diagram illustrating one embodiment of an electronic device.

FIG. 2 shows schematic view of an unlocking notification interface of the electronic device of FIG. 1.

FIG. 3 is a flowchart of one embodiment of a method for fast activating applications of the electronic device after the electronic device is unlocked.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean “at least one.”

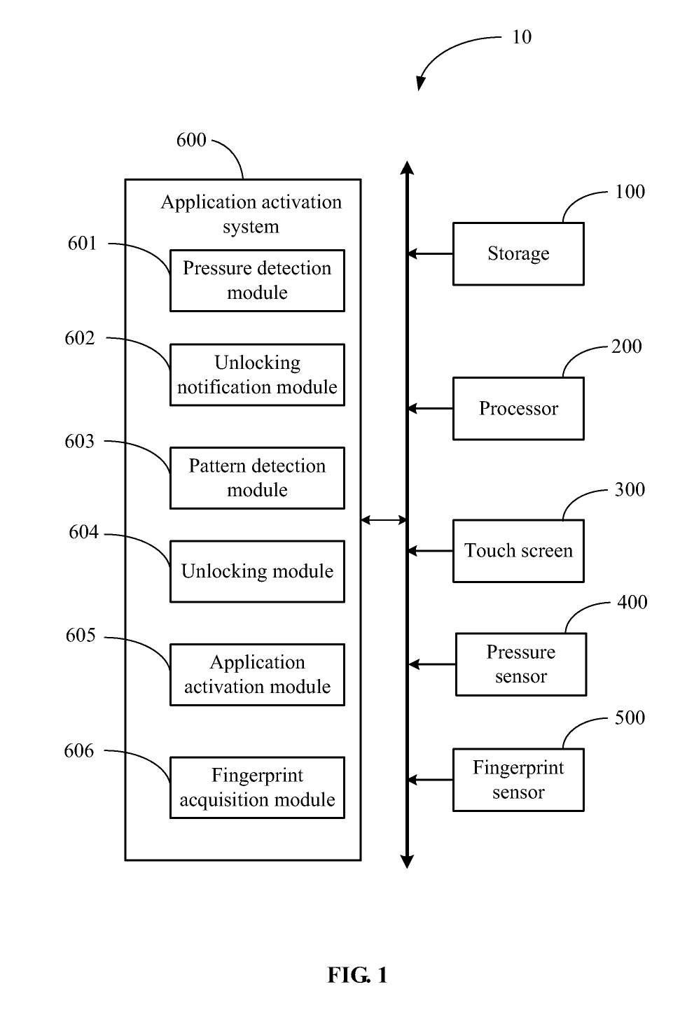

FIG. 1 is a schematic block diagram illustrating one embodiment of an electronic device 10. The electronic device 10 includes a storage 100, a processor 200, a touch screen 300, a pressure sensor 400, a fingerprint sensor 500, and an application activation system 600. FIG. 1 shows one embodiment of the electronic device 10, and it can include more or fewer components than those shown in the embodiment, or have a different configuration of the components.

The pressure sensor 400 is located under the touch screen 300. In this embodiment, when the electronic device 10 is operated to work at an idle state, the pressure sensor 400 detects a pressure applied on the touch screen 300 in real-time. When a detected pressure applied on the touch screen 300 is greater than a predetermined pressure, the electronic device 10 wakes up from the idle state to unlock the electronic device 10.

The application activation system 600 can include a plurality of programs in the form of one or more computerized instructions stored in the storage 100 and executed by the processor 200 to perform operations of the electronic device 10. In the embodiment, the application activation system 600 includes a pressure detection module 601, an unlocking notification module 602, a pattern detection module 603, an unlocking module 604, an application activation module 605, and a fingerprint acquisition module 606. The storage 100 can be an external or embedded storage medium of the electronic device 10, such as a secure digital memory (SD) card, a Trans Flash (TF) card, a compact flash (CF) card, or a smart media (SM) card.

In general, the word “module,” as used herein, refers to logic embodied in hardware or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or hardware modules and may be stored in any type of non-transitory computer-readable medium or other storage devices. Some non-limiting examples of non-transitory computer-readable medium include CDs, DVDs, BLU-RAY, flash memory, and hard disk drives.

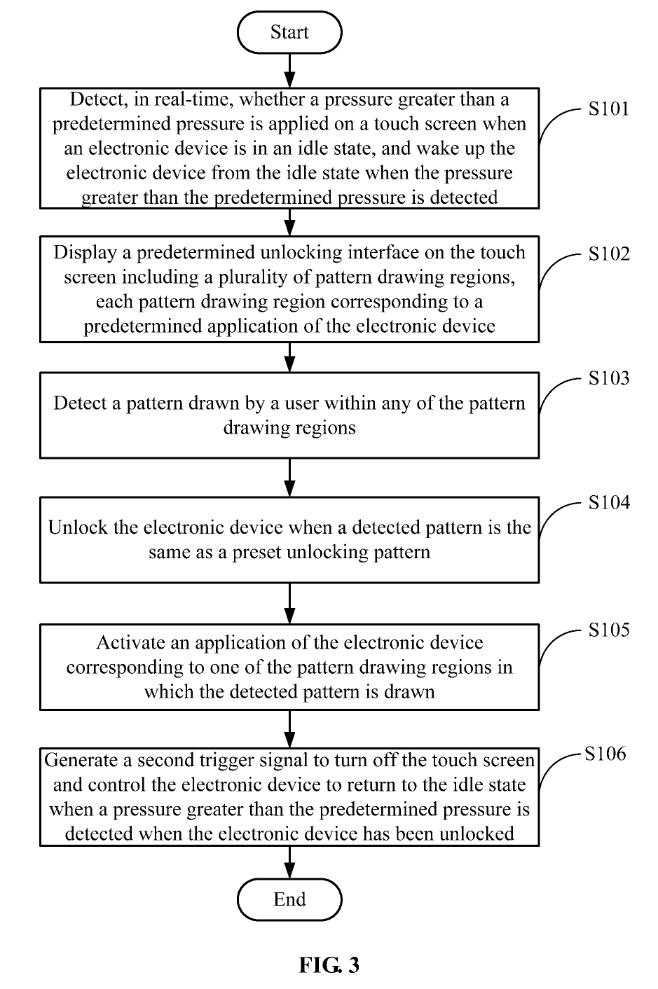

FIG. 3 shows a flowchart of one embodiment of a method for fast activating applications of the electronic device after the electronic device is unlocked using the functional modules of the application activation system 600 of FIG. 1. Depending on the embodiment, additional steps may be added, others removed, and the ordering of the steps may be changed.

In step S101, when the electronic device 10 is operated to work in the idle state, the pressure detection module 601 detects, in real-time, whether a pressure greater than the predetermined pressure is applied on the touch screen 300 using the pressure sensor 400. When the pressure greater than the predetermined pressure is detected, the pressure detection module 601 generates a first trigger signal to wake up the electronic device 10 from the idle state. In this embodiment, the predetermined pressure can be preset by a user of the electronic device. For example, the predetermined pressure can be about 0.5 Newton (N).

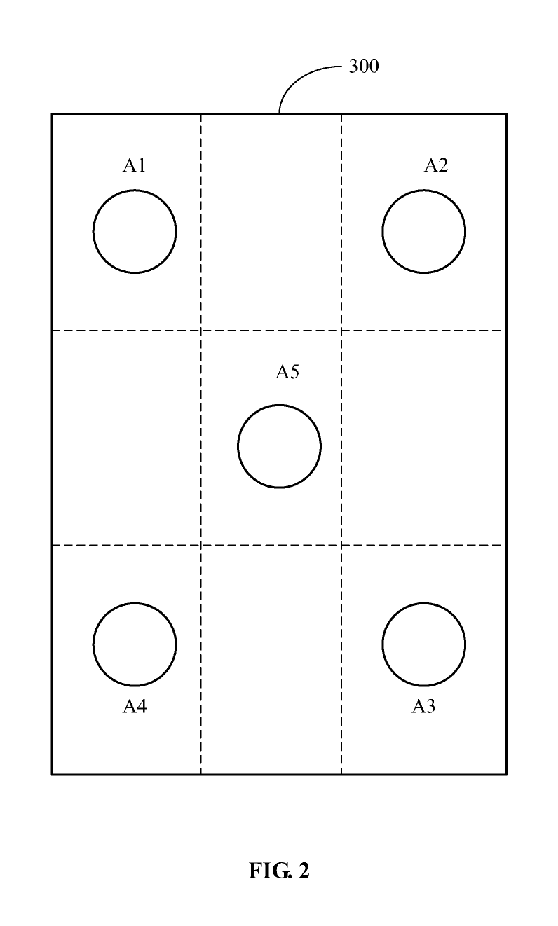

In step S102, when the electronic device wakes up from the idle state, the unlocking notification module 602 displays a predetermined unlocking interface on the touch screen 300. One embodiment of the predetermined unlocking interface is shown in FIG. 2. The predetermined unlocking interface includes a plurality of pattern drawing regions, such as a first region A1, a second region A2, a third region A3, a fourth region A4, and a fifth region A5, to notify a user to draw a pattern within any of the pattern drawing regions to unlock the electronic device 10. In this embodiment, each pattern drawing region is configured to receive a pattern drawn by a user within the pattern drawing region. In addition, each pattern drawing region corresponds to a predetermined application of the electronic device 10. Each pattern drawing region can be a rectangular region or a circular region.

In step S103, the pattern detection module 603 detects a pattern drawn by the user within any of the pattern drawing regions. In this embodiment, the detected pattern is formed by a continuous track drawn by the user within a pattern drawing regions in a predetermined time period, such as about three seconds.

In step S104, the unlocking module 604 compares the detected pattern with a preset unlocking pattern to determine whether or not the detected pattern is the same as the preset unlocking pattern, and unlocks the electronic device 10 when the detected pattern is the same as the preset unlocking pattern. In this embodiment, the preset unlocking pattern can be set by the user and prestored in the storage 100 of the electronic device 10.

In step S105, the application activation module 605 activates an application of the electronic device 10 corresponding to one of the pattern drawing regions in which the detected pattern is drawn, when the electronic device 10 is unlocked.

In one example, the first region A1, the second region A2, the third region A3, the fourth region A4, and the fifth region A5 of FIG. 2 respectively correspond to a first application (e.g., “contact”), a second application (e.g., “message”), a third application (e.g., “media player”), a fourth application (e.g., “browser”), and a fifth application (e.g., “home screen”) of the electronic device 10. If the detected pattern drawn in one of the first, second, third, fourth, and fifth regions, is the same as the preset unlocking pattern, a corresponding application is activated when the electronic device 10 is unlocked. For example, if a pattern drawn in the first region A1 is the same as the preset unlocking patter, the electronic device 10 is first unlocked by the unlocking module 604, and the first application (e.g., “contact”) is then activated by the application activation module 605.

In step S106, the pressure detection module 601 detects, in real-time, whether a pressure greater than the predetermined pressure is applied on the touch screen 300 using the pressure sensor 400 when the electronic device 10 has been unlocked. When the pressure greater than the predetermined pressure is detected, the pressure detection module 601 generates a second trigger signal to turn off the touch screen 300 of the electronic device 10 and control the electronic device 10 to return to the idle state.

In other embodiments, the fingerprint acquisition module 606 acquires a fingerprint of the user using the fingerprint sensor 500 when the electronic device 10 wakes up. The unlocking module 604 determines whether or not the acquired fingerprint sensor is the same as a preset fingerprint. Only when the acquired fingerprint sensor is the same as the preset fingerprint and the detected pattern is the same as the preset unlocking pattern, can the electronic device 10 be unlocked by the unlocking module 604.

As described above, when the electronic device 10 is unlocked, a corresponding application (e.g., an usually used application) can be automatically activated. Thus, it is convenient for the user.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. A computerized method for fast activating applications of an electronic device having a touch screen, the method comprising:
displaying a predetermined unlocking interface on the touch screen when the electronic device wakes up from an idle state, the predetermined unlocking interface comprising a plurality of pattern drawing regions, each pattern drawing region corresponding to a predetermined application of the electronic device;
detecting a pattern drawn by the user within any of the pattern drawing regions;
unlocking the electronic device when a detected pattern is the same as a preset unlocking pattern; and
activating an application of the electronic device corresponding to one of the pattern drawing regions in which the detected pattern is drawn when the electronic device is unlocked.

2. The method according to claim 1, wherein the preset unlocking pattern is prestored in a storage of the electronic device.

3. The method according to claim 1, wherein the step of unlocking the electronic device comprises comparing the detected pattern with the preset unlocking pattern to determine whether or not the detected pattern is the same as the preset unlocking pattern.

4. The method according to claim 1, wherein the electronic device further comprises a pressure sensor located under the touch screen.

5. The method according to claim 4, further comprising:
detecting, in real-time, whether a pressure greater than a predetermined pressure is applied on the touch screen using the pressure sensor when the electronic device is working in the idle state; and
generating a first trigger signal to wake up the electronic device from the idle state when the pressure greater than the predetermined pressure is detected.

6. The method according to claim 4, further comprising:
detecting, in real-time, whether a pressure greater than a predetermined pressure is applied on the touch screen using the pressure sensor when the electronic device has been unlocked; and
generating a second trigger signal to turn off the touch screen of the electronic device and to control the electronic device to return to the idle state, when a pressure greater than the predetermined pressure is detected.

7. The method according to claim 1, wherein each of the pattern drawing regions is a rectangular region or a circular region.

8. An electronic device, comprising:
a touch screen;
a storage;
a processor; and
one or more programs executed by the processor to perform a method for fast activating applications of the electronic device, the method comprising:
displaying a predetermined unlocking interface on the touch screen when the electronic device wakes up from an idle state, the predetermined unlocking interface comprising a plurality of pattern drawing regions, each pattern drawing region corresponding to a predetermined application of the electronic device;
detecting a pattern drawn by the user within any of the pattern drawing regions;
unlocking the electronic device when a detected pattern is the same as a preset unlocking pattern; and
activating an application of the electronic device corresponding to one of the pattern drawing regions in which the detected pattern is drawn when the electronic device is unlocked.

9. The electronic device according to claim 8, wherein the preset unlocking pattern is prestored in the storage of the electronic device.

10. The electronic device according to claim 8, wherein the step of unlocking the electronic device comprises comparing the detected pattern with the preset unlocking pattern to determine whether or not the detected pattern is the same as the preset unlocking pattern.

11. The electronic device according to claim 8, further comprising a pressure sensor located under the touch screen.

12. The electronic device according to claim 11, wherein the method further comprises:
detecting, in real-time, whether a pressure greater than a predetermined pressure is applied on the touch screen using the pressure sensor when the electronic device is working in the idle state; and
generating a first trigger signal to wake up the electronic device from the idle state when the pressure greater than the predetermined pressure is detected.

13. The electronic device according to claim 11, wherein the method further comprises:
detecting, in real-time, whether a pressure greater than a predetermined pressure is applied on the touch screen using the pressure sensor when the electronic device has been unlocked; and
generating a second trigger signal to turn off the touch screen of the electronic device and to control the electronic device to return to the idle state, when a pressure greater than the predetermined pressure is detected.

14. The electronic device according to claim 8, wherein each of the pattern drawing regions is a rectangular region or a circular region.
